(19) United States
(12) Patent Application Publication
(10) Pub. No.: US 2008/0082392 A1
(43) Pub. Date: Apr. 3, 2008

(54) System for Carrying Out Industrial Business Process

(76) Inventors: Stefan Behr, Rosstal/OT Oedenreuth (DE); Steffen Kocher, Cadolzburg (DE); Vijay Kumar, Erlangen (DE); Markus Singer, Erlangen (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/661,814

(22) PCT Filed: Aug. 30, 2005
(86) PCT No.: PCT/EP05/54258

§ 371 Date: Mar. 1, 2007

(30) Foreign Application Priority Data
Sep. 6, 2004 (DE) 10 2004 043 419.0

(51) Int. Cl. G06Q 10/00; G06F 19/00

(52) U.S. Cl. 705/9

(57) ABSTRACT

The invention relates to a system for carrying out an industrial business process, which comprises means for graphically modeling the business process as an event-controlled process chain. An event-controlled process chain comprises interlinked work packages which are adapted to trigger at least one event each. The dependencies of the work packages are defined by means of the connections of the work packages. A work package is adapted to receive an event from the preceding work package and a work package is adapted to hand over an event to the subsequent work package. The fact that at least one work package can trigger a plurality of events, whereby every one of these events can be handed over to the subsequent work package independent of the other events, accelerates process execution and therefore reduces handling time and costs.

### CROSS REFERENCE TO RELATED APPLICATIONS

This application is the US National Stage of International Application No. PCT/EP2005/054258, filed Aug. 30, 2005 and claims the benefit thereof. The International Application claims the benefits of German application No. 10 2004 043 419.0 filed Sep. 6, 2004, both of the applications are incorporated by reference herein in their entirety.

### FIELD OF INVENTION

The invention relates to a system for carrying out an industrial business process with means for graphical modeling of the business process as an event-controlled process chain, with an event-controlled process chain featuring interlinked work packages through which at least one event is able to be triggered in each case, where the dependencies of the work packages are able to be defined via the connections of the work packages, by an event being able to be accepted by a work package from its preceding work package and by an event being able to be handed on by a work package to its succeeding work package.

### BACKGROUND OF THE INVENTION

Industrial business processes are identified by their great complexity, size and long run times. A coordinated interaction between a multiplicity of persons is required for carrying them out and this frequently occurs in a cross-company or cross-site environment. Changing customer requirements or new knowledge about improvements in process handling systems frequently require the process to be adapted during its execution. As a rule a heterogeneous information technology landscape is associated with this. A few examples of such processes are the product creation, project handling, offer creation and system setup process.

To achieve a maximum commercial result and the optimum customer satisfaction carrying out industrial business processes must be highly efficient in its planning and execution of the process to comply with contractually-agreed deadlines as well to reduce its handling times and thereby its costs. In addition the reworking costs must be kept low by avoiding repeated execution and adjustment. Furthermore a high level of quality conformity for increasing customer acceptance is demanded. Finally the status, the progress and the performance of the business process must be able to be presented in an up-to-the-minute manner, to strengthen the management's ability to act. To implement these features the visible, consistent, transparent, up-to-date, comprehensible and coordinated management of the lifecycle of a business process, i.e. its modeling, planning, execution, monitoring and run time optimization is necessary.

The tool ARIS, with which industrial business processes can be graphically defined, designed and simulated, is known from the Internet source http://www.ids-scheme.DE as well as from DE publication “Computerwoche, Sonderdruck aus No. 26 (special edition reprinted from No. 26) dated Jun. 29, 2001”. ARIS enables the process to be presented graphically as an event-controlled process chain. An event-controlled process chain consists of interconnected work packages. The connections define the dependencies of the respective work packages. A work package receives events from its predecessors and supplies events to its successors. The connections between the work packages define the event flow and thereby the workflow underlying the process. The process diagram allows connections between the work packages with a cardinality of 1, i.e. the connections between two work packages represent a single event. The planning, monitoring and run time optimization of the business processes are not an object of ARIS. With the process-to-engineering approach the process model is converted into a suitable programming language. This means that the model loses its visibility and flexibility, i.e. runtime adaptations are not possible.

The object of the invention is to provide a system of the type outlined above, with which the progress of the process is accelerated in order to reduce the handling time and thereby the costs of industrial business processes.

In accordance with the invention the object is achieved by a generic system in which a number of events are triggered by at least one work package, with each of these events being able to be handed over independently of the other events to the subsequent work package. A process model based on an event-controlled process chain offers all those involved a visible, consistent, transparent and easy-to-handle basis for executing the entire life cycle of industrial business processes. The connections between the work packages define the event flow and thus the workflow underlying the business process, which, according to the invention, has cardinality greater than 1. The working steps of a work package are listed in a checklist, with a separate event being able to be triggered according to the invention by each checklist point. This accelerates process execution and thus reduces handling time and costs.

In an advantageous embodiment of the inventive system this system is embodied with Internet capabilities. This allows coordinated process modeling between all those involved and accelerates the model formation process in a cross-company and cross-site arrangement.

In a preferred embodiment of the inventive system the means are embodied for hierarchical modeling of the business process. This makes a better presentation of the process logic possible.

In an advantageous embodiment of the inventive system means are provided for storage of modeled business processes. This enables reusable templates of business processes to be provided, which makes it possible to implement standardized business processes. The creation of process entities based on standardized templates leads to reduction of the costs arising for each process entity as regards its creation, maintenance and administration.

In a further preferred embodiment of the inventive system means are provided for planning the business process, with a suitable modeled business process being able to be selected and on the basis of this a process entity of the operational business process being able to be created. In this case the process planning needs the definition of all work packages which are placed at the topmost hierarchical level of the process chain.

Preferably responsibilities and due dates can be allocated to the work packages in the process entity created. I.e. the responsibilities and due dates are planned in the graphical presentation of the process.

In a further advantageous embodiment of the inventive system work packages which are placed in the hierarchically subordinate levels of the event-controlled process chain are only able to be defined during process execution. The contents of a hierarchical work package, i.e. a subordinate event-controlled process chain, can be defined and planned at a later, but suitable point in time during the process execution. This enables what is known as the “delayed model” to be implemented. The unknown details of a process can thus be agreed retrospectively, inserted in a consistent and verifiable manner.

In a preferred embodiment of the inventive system means are provided for executing the business process which feature means for graphical presentation of the modeled and planned business process, with the event-controlled process chain being able to be executed in the graphical presentation. The coordinated execution of a process in accordance with its schedule is undertaken in the graphical process diagram by all those involved, depending on the resources planned in. The process execution only deals with the execution of the event-driven process chain.

Preferably for execution of a work package with a checklist of work points result documents are able to be added to the checklist points and the checklist points are able to be acknowledged to trigger an event to be controlled. A work package is executed by the person responsible by addition of result documents to the checklist points. The events controlling the workflow are triggered by the confirmation or acknowledgement of checklist points. The mechanisms for acknowledging the results and their presentation in the graphical process diagram improve the quality assurance. The result acceptance mechanisms increase the quality conformity and minimize the reworking costs.

In a further preferred embodiment of the inventive system means are provided for monitoring the business process, through which a critical path as well as a probable schedule based one the directed acyclic process graphs are able to be determined and graphically presented. The critical path of the process is determined with reference to the directed acyclic process graphs and identified in an up-to-date form in the graphical process diagram. The triggers for the calculation are process changes, both status and also structure changes. A probable schedule is determined from the process graphs and this is also presented graphically.

In another preferred embodiment of the inventive system a status of the business process to be carried out is able to be presented graphically. The process status, that is the status of the respective work packages, their progress, performance and probable schedule, is provided to management in an up-to-date and graphical form. The automatic calculation of the probable schedules and their clear presentation support those involved in their own work planning.

In a further advantageous embodiment of the inventive system communication means are provided, by means of which the impending due dates and due date changes can be communicated to the persons involved. Communication means considered in such cases are for example e-mail, Short Message Service or voicemail. An automatic notification of a status change and outstanding due dates to persons involved reduces the handling times and thus the costs of the industrial business process.

In another advantageous embodiment of the inventive system means are provided for optimizing the duration of the business process, with an image of the process able to be stored and processed. As a result of new information about improvements in the execution system and changes in the business environment, for example customer requirements, the process may have to be adapted in its structures and planning. To this end a snapshot of the process status is saved for trying out and qualifying optimization approaches.

Preferably changes are able to be made to structure, execution sequence and plan in the saved process image and the changed process image provided for processing. Saving the process image allows changes to be made in the non-executed part of the process. The adaptation of the progress of the event-controlled process chain during process execution enables a consistent, transparent and verifiable recording of business changes. Process execution sequences can be optimized by this in the sense of a continuous process improvement.

A corresponding method for carrying out an industrial business process as well as a computer program product, with which an inventive system to execute the method is trained, are also claimed. Furthermore electronic data processing means are claimed, from which the inventive system is composed and on which the computer program product can be executed.

### BRIEF DESCRIPTION OF THE DRAWINGS

Further advantages and an exemplary embodiment of the invention will be explained in greater detail below with reference to drawings, in which:

FIG. 1 shows an event-controlled process chain of the topmost hierarchy level of a business process,

FIG. 2 shows an event-controlled process chain of a subordinate hierarchy level of a business process,

FIG. 3 shows an event-controlled process chain of a further subordinate hierarchy level of a business process,

FIG. 4 shows an information overview of a work package of a business process,

FIG. 5 shows a checklist with workpoints of a work package of a business process as schematic diagrams.

### DETAILED DESCRIPTION OF INVENTION

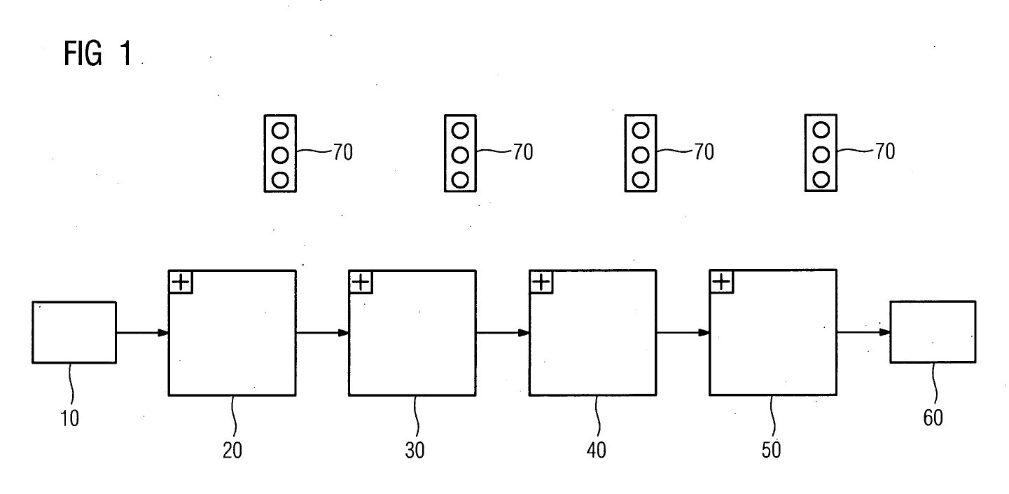

The industrial business process to be carried out described in the exemplary embodiment is the commissioning process for a transformer. In accordance with the graphic shown in FIG. 1, as might appear on the screen of an operating console of someone involved in the process, the process entity of the commissioning is modeled as an event-controlled process chain 1, which begins with start field 10 and executes a number of work packages 20 to 50, before concluding with end field 60. The chain involved here is the process chain 1 of the highest hierarchy level. In the exemplary embodiment shown the work package 20 comprises precautionary measures, work package 30 tests on the components of the transformer, work package 40 functional tests and work package 50 integral tests. Above each of work packages 20 to 50 is shown a signaling element 70, with reference to which a person involved can read off whether a specific work package is fully processed, is being processed or is ready for processing. To request further information about a specific work package, this information can be selected via software—for example via keyboard or computer mouse. The plus sign arranged in the top left corner of the relevant graphical symbol is used for this purpose.

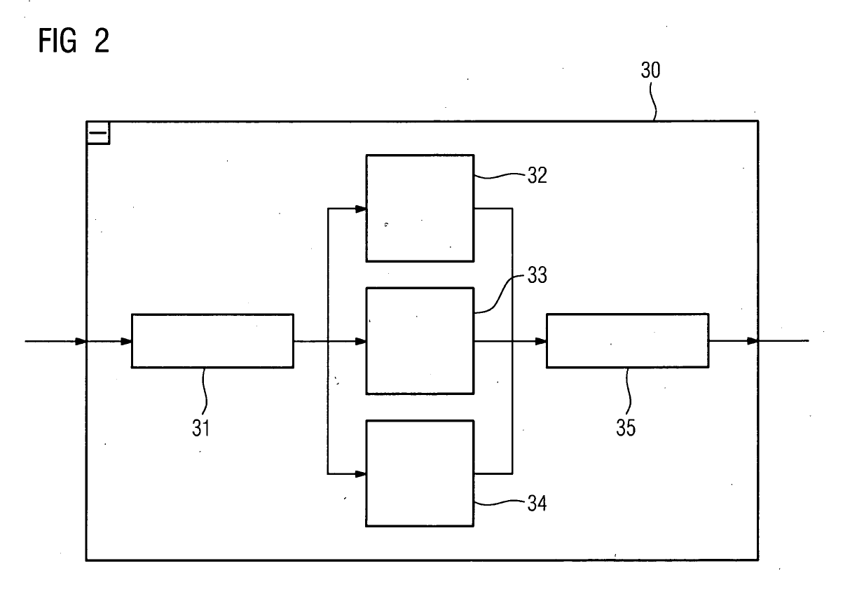

This leads to the diagram shown in FIG. 2 relating to the selected work package 30 “Tests on the components”. Behind this work package 30 is concealed a further event-controlled process chain which begins with the field 31 “Initiate tests”, branches to work package 32 “Tests on the transformer itself”, to work package 33 “Tests on the instrumentation” to work package 34 “Tests on the electrical drive” in order to finally end with field 35 “Release of the tests”. If all workpoints in a work package of this hierarchically subordinate process chain are dealt with by addition of result documents, an event is triggered and handed over to the next work package. Once all work packages are completed, superordinate work package 30 “Tests on components” is deemed to be completed. A corresponding event is then handed over to the next work package 40 “Function tests” (cf. FIG. 1).

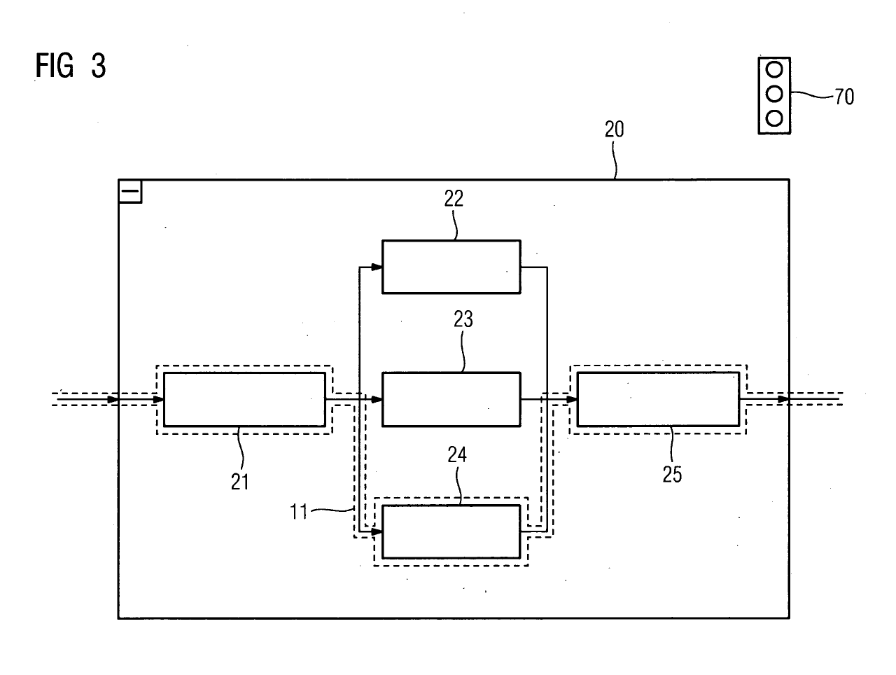

If on the other hand the work package 20 “Precautionary measures” is selected in FIG. 1, the display shown in FIG. 3 will appear on the display means. Thus, before the tests on the components of the transformer are executed, the modeled and planned commissioning process prescribes specific precautionary measures as preceding work package 20. This work package 20 begins with the start field 21 “Initiate measures” and branches into three work packages, namely work package 22 “Obtain work permission”, work package 23 “Secure access” and work package 24 “Meet safety requirements”. Once all three work packages are completed, the process chain “Precautionary measures” ends with field 25 “Work release”. In this case, the so-called critical path 11 of the commissioning process is specifically marked in the event-controlled process chain—shown in FIG. 3 by dashed lines—which leads through the work package 24 “Meet safety requirements”.

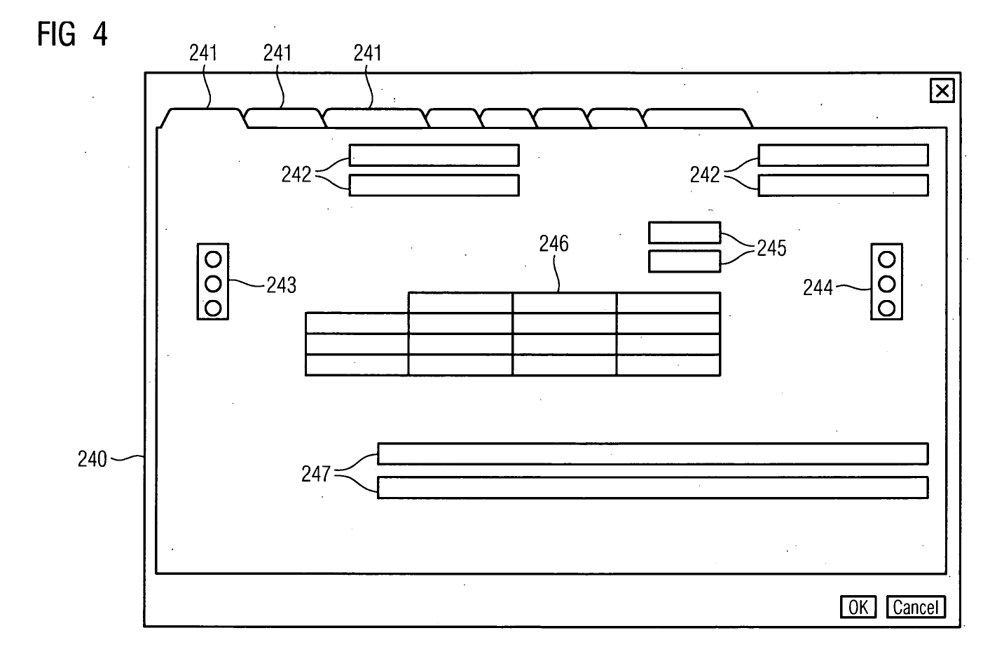

To obtain more information about a work package, the corresponding symbol, for example work package 24 can be clicked on, which opens an information window on the screen. FIG. 4 shows such a screen. Window 240 is overlaid onto the process diagram and, in the form of selectable tabs 241, provides different categories of information, for example an overview, a description, responsibilities, the costs, the risks, the work steps to be carried out, a calendar as well as electronic links to documents of this work package. Shown in FIG. 4 are the overview information to which the name and the number of the work packages 24 belong as well as the work location and where necessary the superordinate work package 20; this information is identified by reference symbol 242. Signaling elements for the input and output of work package 24 are shown in field 243 or 244 respectively. The overview information also includes in field 245 information about specific risks which can occur in the work package 24, as well as the information about whether the work package 24 lies on the critical process path 11. A schedule for this work package 24 is created in field 246. The performance or the progress of this work package 24 are finally illustrated in field 247 by bar charts.

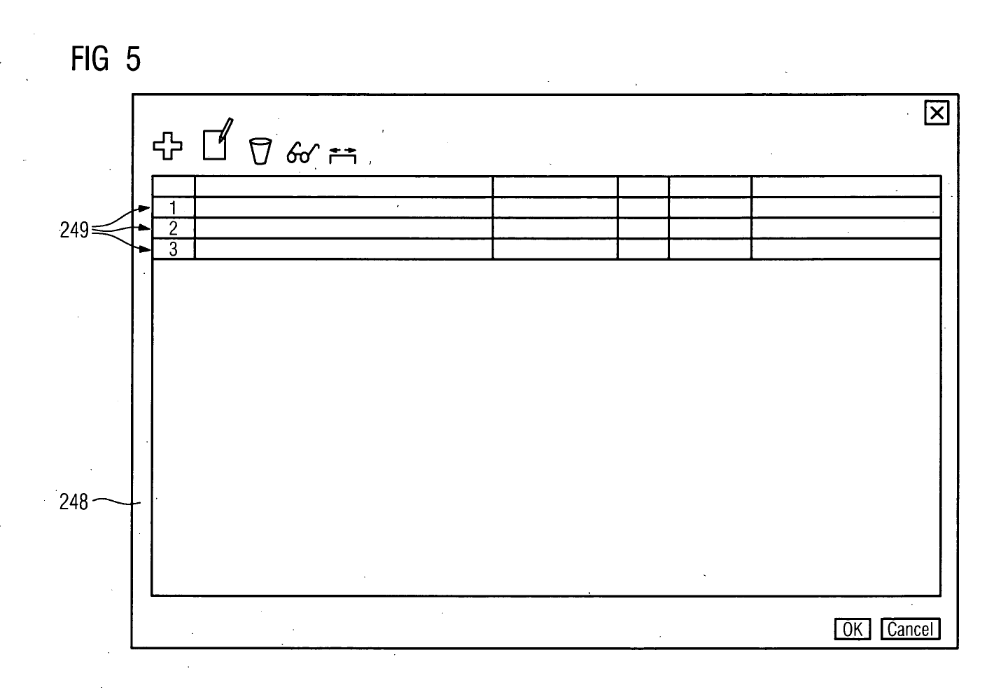

A further selection of the view from FIG. 4 enables a checklist 248 to be opened, which is shown in FIG. 5 and from which the individual working steps 249 with name, status, priority and degree of completion can be seen. Each checklist point dealt with can trigger an event independent of the others which is accepted by a subsequent work package in each case. These multiple connections between work packages, a cardinality of more than 1 is referred to here, enable the entire industrial business process to be handled much more quickly than was possible in the prior art.

Overall the inventive system makes a coordinated execution of an industrial business process possible through a presentation which is visible, consistent, current and accessible to all those involved. The quality of the results, the productivity of those involved and the management's ability to act are thus all improved. These are fundamental requirements for achieving a maximum business result and optimum customer satisfaction.

1.-14. (canceled)

15. A system for carrying out an industrial business process, comprising:
a graphical modeling device that graphically models the business process as an event-controlled process chain featuring interconnected work packages through which at least one event is activated, with the dependencies of the work packages defined by the connections of the work packages by an event to be accepted by a work package from its preceding work package and an event being passed on by a work package to its subsequent work package,
wherein a plurality of events are triggered by a work package, where each event is transferable to the subsequent work package independently of the other events.

16. The system as claimed in claim 15, wherein the system is connected to the Internet.

17. The system as claimed in claim 16, wherein the graphical modeling device is embodied for hierarchical modeling of the business process.

18. The system as claimed in claim 17, further comprising a device that stores modeled business processes.

19. The system as claimed in claim 18, wherein a modeled business process is selected and a process entity of the operational business process to be carried out is created based on a suitably of the modeled business process.

20. The system as claimed in claim 19, wherein responsibilities and due dates are allocated to the work packages in the created process entity.

21. The system as claimed in claim 20, wherein a plurality of work packages placed in hierarchically subordinate levels of the event-controlled process chain are only defined during the process execution.

22. The system as claimed in claim 21, further comprising a device for graphical presentation of the modeled and planned business process, where the event-controlled process chain is executed in the graphical presentation.

23. The system as claimed in claim 22, wherein, for execution of a work package having a checklist of work points, result documents are added to the checklist points that are acknowledged for triggering a controlling event.

24. The system as claimed in claim 23, further comprising a device for monitoring the business process, whereby a critical path as well as a probable schedule is determined and graphically presented based on a directed acyclic process graph.

25. The system as claimed in claim 24, wherein a status of the business process to be carried out is presented graphically.

26. The system as claimed in claim 25, further comprising a communication device that communicates impending due dates and due date changes.

27. The system as claimed in claim 26, further comprising an optimization device that optimizes a run time of the business process where an image of the process is stored and processed.

28. The system as claimed in claim 27, wherein changes to structure, execution sequence and plan are made in the saved process image and are provided to a changed image for processing.
